(19) United States
(12) Patent Application Publication
(10) Pub. No.: US 2007/0120375 A1
(43) Pub. Date: May 31, 2007

(54) Display box

(75) Inventor: Kinsen Ka Fai Au, Hong Kong (HK)

Correspondence Address: Raymond Y. Chan, 108 N. Ynez Ave., #128, Monterey Park, CA, 91754, US

(73) Assignee: Nationalpak Limited

(21) Appl. No.: 11/291,943

(22) Filed: Nov. 30, 2005

(51) Int. Cl. E05C 1/08

(52) U.S. Cl. 292/163

(57) ABSTRACT

A display box includes a box body, a foldable cover having a locker rim portion and a pivot rim portion pivotally connected to the box body to fold between an opened position and a closed position, and an aesthetic locking arrangement. The aesthetic locker includes a sliding tongue slidably mounted at the box body and a rim locker which is extended from the sliding tongue and is arranged in such a manner that when the sliding tongue is slid towards the box body, the rim locker is substantially engaged with the locker rim portion of the foldable cover, and when the sliding tongue is slid away from the box body, the rim locker is driven to disengage with the locker rim portion of the foldable cover such that the foldable cover is free to pivotally fold between the opened position and the closed position.

### BACKGROUND OF THE PRESENT INVENTION

1. Field of Invention

The present invention relates to a box, and more particularly to a display box which comprises an aesthetic locking arrangement for selectively locking up a foldable cover of the display box.

2. Description of Related Arts

A conventional display box typically comprises a box body and a foldable cover pivotally mounted on the box body to selectively enclose a storage compartment defined within the box body. In many occasions, it is desirable that the foldable cover be locked with the box body.

As a result, the conventional display box may further comprise a locking device provided on the box body for allowing a user to manually lock up the foldable cover with the box body. There are several reasons that a user may wish to lock up the foldable cover. For example, he/she may wish to prevent unauthorized access to the storage compartment so as to protect the object stored or displayed in the box body. Another reason may be that the user simply wishes to prevent accidental opening of the foldable cover in order to prevent certain inconvenient or embarrassing scenarios.

There are two major disadvantages of this type of conventional display box. First, the locking device usually becomes an aesthetically unsound creature appearing on the display box so as to significantly affect an overall aesthetic impression of the objects displayed in the storage compartment. Consequently, the market value or attractiveness of the object displayed in the display box may be severely undermined.

Another problem is that a conventional locking device is usually inconvenient, if not difficult, to operate so that many users of conventional display boxes simply choose not to use those display boxes which have the locking devices. For example, they may put the objects displayed to another container or box for convenient carrying or storage.

As a matter of fact, some locking devices require the user to prepare a separate lock for locking the foldable cover with the box body. This is very inconvenient and when the user does not have a separate lock at hands, the display box cannot be locked at all.

### SUMMARY OF THE PRESENT INVENTION

A main object of the present invention is to provide a display box which comprises an aesthetic locking arrangement for selectively locking up a foldable cover of the display box.

Another object of the present invention is to provide a display box which comprises the aesthetic locking arrangement, wherein the aesthetic locking arrangement not only conveniently locks up the foldable cover with a main box body, but also optimally match with an aesthetic appearance of the box body and the foldable cover so as to impute an impressive appearance to the display box even when it is provided with the aesthetic locking arrangement.

Another object of the present invention is to provide a display box comprising an aesthetic locking arrangement which is easy to operate yet facilitating effective locking of the foldable cover. In other words, the present invention is specifically designed to facilitate widespread applications thereof.

Another object of the present invention is to provide a display box comprising an aesthetic locking arrangement, wherein the user does not need to prepare his/her own separate lock for locking the foldable cover with the box body.

Another object of the present invention is to provide a display box which does not involve complicated mechanical structure so as to minimize the manufacturing cost as well as the ultimate selling price of the present invention.

Accordingly, in order to accomplish the above objects, the present invention provides a display box, comprising:

a box body having a storage compartment and an access opening communicating with the storage compartment;

a foldable cover having a locker rim portion and a pivot rim portion pivotally connected to the box body to pivotally fold between an opened position that the foldable cover is pivotally unfolded to expose the storage compartment and a closed position that the foldable cover is pivotally folded at the access opening to enclose the storage compartment; and

an aesthetic locking arrangement, which comprises:

an aesthetic locker comprising a sliding tongue slidably mounted at the box body and a rim locker which is extended from the sliding tongue and is arranged in such a manner that when the sliding tongue is slid towards the box body, the rim locker is substantially engaged with the locker rim portion of the foldable cover so as to lock up the foldable cover at the closed position, and when the sliding tongue is slid away from the box body, the rim locker is driven to disengage with the locker rim portion of the foldable cover such that the foldable cover is free to pivotally fold between the opened position and the closed position.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of the display box according to the above preferred embodiment of the present invention.

FIG. 2A and FIG. 2B are schematic diagrams of the display box according to the above preferred embodiment of the present invention, illustrating that the foldable cover is locked at a closed position.

FIG. 3A and FIG. 3B are schematic diagrams of the display box according to the above preferred embodiment of the present invention, illustrating that the foldable cover is unlocked for folding to an opened position.

### DETAILED DESCRIPTION OF THE PREFERRED EMBODIMENT

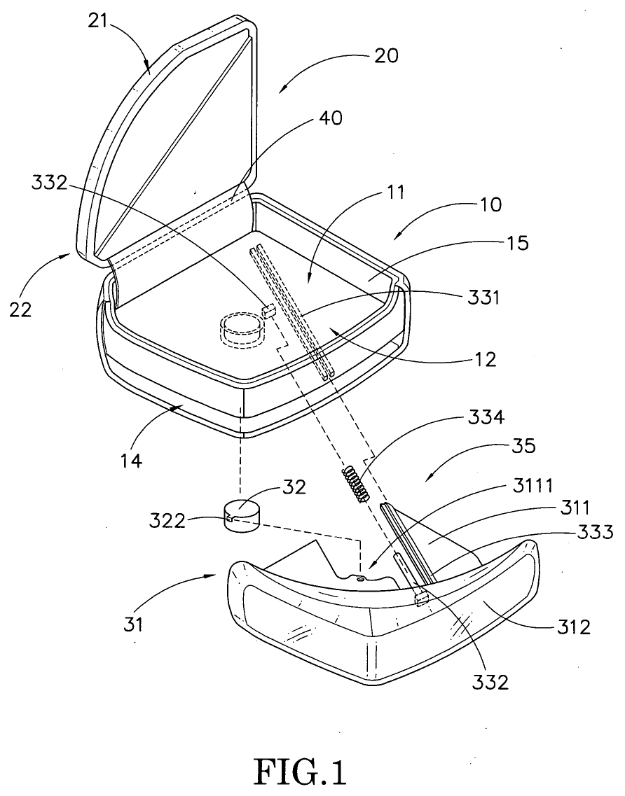

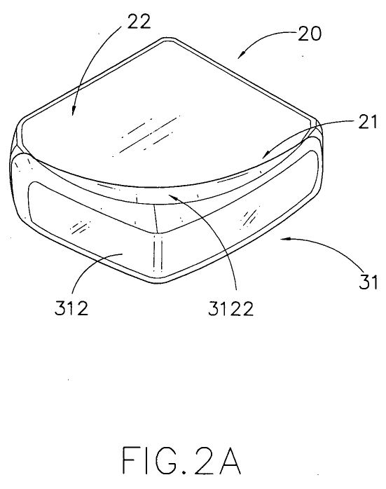

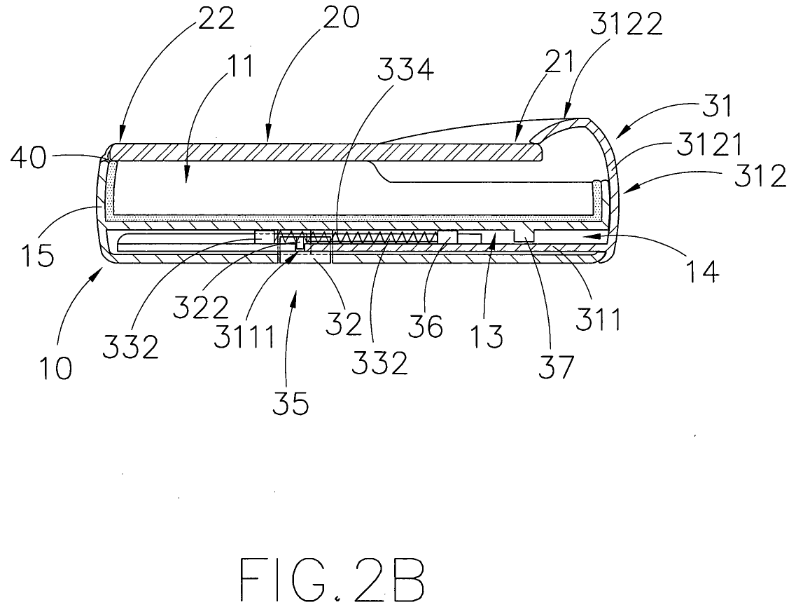

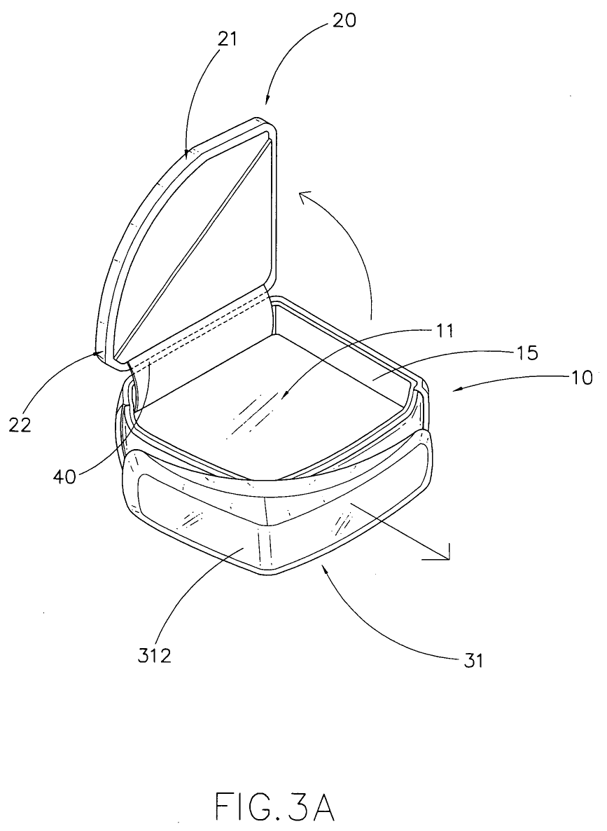

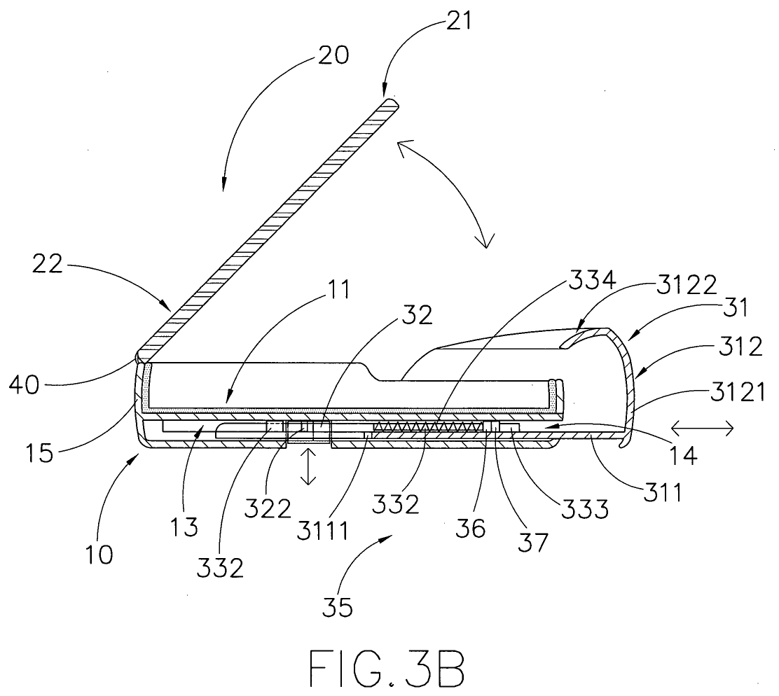

Referring to FIG. 1, FIG. 2A, FIG. 2B, FIG. 3A and FIG. 3B of the drawings, a display box according to a preferred embodiment of the present invention is illustrated, in which the display box comprises a box body 10, a foldable cover 20, and an aesthetic locking arrangement.

The box body 10 has a storage compartment 11, and an access opening 12 communicating with the storage compartment 11.

The foldable cover 20 has a locker rim portion 21 and a pivot rim portion 22 pivotally connected to the box body 10 to pivotally fold between an opened position that the foldable cover 20 is pivotally unfolded to expose the storage compartment 11 and a closed position that the foldable cover 20 is pivotally folded at the access opening 12 to enclose the storage compartment 11.

The aesthetic locking arrangement comprises an aesthetic locker 31 comprising a sliding tongue 311 slidably mounted at the box body 10, and a rim locker 312 which is extended from the sliding tongue 311 and is arranged in such a manner that when the sliding tongue 311 is sidewardly slid towards the box body 10, the rim locker 312 is substantially engaged with the locker rim portion 21 of the foldable cover 20 so as to lock up the foldable cover 20 at the closed position, and when the sliding tongue 311 is sidewardly slid away from the box body 10, the rim locker 312 is driven to disengage with the locker rim portion 21 of the foldable cover 20 such that the foldable cover 20 is free to pivotally fold between the opened position and the closed position.

According to the preferred embodiment of the present invention, the box body 10 is preferably quadrilateral in shape having four sidewalls 15 defining the access opening 12 and the storage compartment 11 within the access opening 12. Moreover, the box body 10 further has a sliding cavity 13 formed above a bottom wall of the box and underneath the storage compartment 11 thereof, and a sliding opening 14 formed on a sidewall of the box body 10 to communicate with the sliding cavity 13, wherein the sliding tongue 311 slidably received in the sliding cavity 13 through the sliding opening 14 so as to slidably mount the rim locker 312 with the box body 10 for selectively locking and unlocking the foldable cover 20.

Accordingly, the foldable cover 20 is preferably embodied as planar in shape having a cross section corresponding with the cross section of the box body 10 so that the foldable cover 20 is adapted to fittedly enclose the storage compartment 11 when it is at the closed position. It is worth mentioning that the locker rim portion 21 is substantially aligned with the rim locker 312 of the aesthetic locker 31 for being locked up to prevent the foldable cover 20 from folding to the opened position.

In order to pivotally connect the foldable cover 20 with the box body 10, the display box further comprises a foldable hinge 40 provided on the pivot rim portion 22 of the foldable cover 20 for pivotally connecting the box body 10 with the foldable cover 20.

The rim locker 312 comprises a surrounding wall 3121 and a top engaging rim 3122 integrally extended on top of the two surrounding wall 3121 to define an engaging cavity 3123 within the surrounding wall 3121 and the top engaging rim 3122, wherein the locker rim portion 21 of the foldable cover 20 is arranged to slidably receive into the engaging cavity 3123 when the foldable cover 20 is at the closed position and is locked up by the rim locker 312. In other words, the locker rim portion 21 is slidably received in the engaging cavity 3123 for engaging with the top engaging rim 3122 of the rim locker 312.

Thus, the surrounding wall 3121 is upwardly extended from the sliding tongue 311 and the top engaging rim 3122 is integrally extended on top of the surrounding wall 3121 to ride on the locker rim portion 21 of the foldable cover 20 when the sliding tongue 311 is sidewardly slid towards the box body 10 so as to lock up the foldable cover 20 at the closed position.

Accordingly, a height of the rim locker 312 is preferably slightly larger than a height of the box body 10 overlapped by the foldable cover 20 so that the box body 10 and the locker rim portion 21 of the foldable cover 20 is adapted to be fittedly received into the engaging cavity 3123 for locking the foldable cover 20 at the folded position. Moreover, a height of the sliding cavity 13 is slightly larger than a thickness of the sliding tongue 311 so that it is capable of smoothly sliding within the sliding cavity 13 for locking and unlocking the foldable cover 20.

The top engaging rim 3122 has a curved gripping portion formed on a top surface of the top engaging rim 3122 at a position above the foldable cover 20 such that the gripping portion of the top engaging rim 3122 is adapted to be held to fold the foldable cover 20 between the opened position and the closed position when the sliding tongue 311 is slid away from the box body 10.

On the other hand, the aesthetic locking arrangement further comprises a locker unit 35 for locking the sliding tongue 311 with the box body 10, wherein the locker unit 35 has a locking slot 3111 formed on the sliding tongue 311 and comprises a locking actuator 32, having a locking latch 322 supported within the sliding cavity 13, movably mounted on the bottom wall of the box body 10 and arrange in such a manner that when the sliding tongue 311 is slid towards the box body 10, the locking latch 322 is engaged with the locking slot 3111 to lock up the sliding tongue 311 at the box body 10 so as to retain the rim locker 312 at the locker rim portion 21 of the foldable cover 20 so as to lock up the foldable cover 20 at the closed position.

Thus, the locker unit 35 is supported within the sliding cavity 13 to operatively connect the locking actuator 32 with the aesthetic locker 31 in such a manner that when the locking actuator 32 is actuated, the locker unit 35 is arranged to activate a sliding movement of the aesthetic locker 31 in the sliding cavity 13 so as to disengage the rim locker 312 from the foldable cover 20 for allowing the foldable cover 20 freeing folding between the opened position and the closed position.

In other words, the locking actuator 32 is operatively provided on the box body 10 to couple with the aesthetic locker 31 for allowing a user to selectively unlock the aesthetic locker 31 by actuating the locking actuator 32.

The aesthetic locking arrangement further comprises a slider track 331 elongatedly formed on a top wall of the sliding cavity 13, and a sliding guider 333 elongatedly extended on the sliding tongue 311 to align with the slider track 331, in such a manner that the sliding guider 333 is adapted to engage with the slider track 331 so as to mount the aesthetic locker 31 with the box body 10 in a slidably movable manner along the slider track 331.

In other words, when the locking actuator 32 is actuated, the aesthetic locker 31 is capable of sliding away from the box body 10 so as to disengage the rim locker 312 from the foldable cover 20.

According to the preferred embodiment of the present invention, the locker unit 35 further comprises two spring holders 332 mounted on the sliding tongue 311, and a resilient element 334, which is preferably embodied as a compressive spring, mounted in the sliding cavity 13 for normally exerting an outward pushing force towards the holding shaft so as to normally push the sliding tongue 311 away from the box body 10, wherein one of the spring holders 332 is embodied as a holding shaft which is substantially parallel with the sliding track 331. The holding shaft is arranged to insert into the resilient member 334 which exerts the normal pushing force to the holding shaft for sliding along the sliding track 331. It is worth mentioning that the other spring holder 332 is embodied as an end blocker for retaining the resilient element 334 within the holding shaft.

Thus, the resilient element 334 of the locker unit 35 is supported within the sliding cavity 13 for applying an urging force against the sliding tongue 311 so as to normally push the sliding tongue 311 away from the box body 10. Moreover, the two spring holders 332 are mounted at the sliding tongue 311 and a ceiling of the sliding cavity 13 to securely hold two ends of the compression spring of the resilient element 334 in position respectively.

The aesthetic locking arrangement further comprises a first stopper 36 mounted within the sliding cavity 13, and a second stopper 37 which is mounted on the sliding tongue 311 and is aligned with the first stopper 36 such that when the sliding tongue 311 is slid away from the body box 10, the second stopper 37 is blocked by the first stopper 36 so as to prevent the sliding tongue 311 from sliding out of the sliding cavity 13.

In order to retain the aesthetic locker 31 within the sliding cavity 13 when the locking actuator 32 has not yet been actuated, the locking actuator 32 is embodied as a resilient actuation button provided on the box body 10, wherein the locking latch 322 has one end coupled with the actuation button and another end movably extended within the sliding cavity 13.

In other words, when the resilient actuation button 321 is depressed, the locking latch 322 is upwardly pulled to disengage from the locking slot 3111, wherein the sliding tongue 311 is then allowed to be pushed by the resilient element 334 for disengaging the rim locker 312 with the locker rim portion 21 of the foldable cover 20, as shown in FIG. 3B of the drawings. As a result, the foldable cover 20 is free to pivotally fold between the opened position and the closed position.

It is important to mention at this point that the aesthetic locker 31 is specifically designed to form an aesthetically sound and consistent appearance to match with the box body 10 in such a manner that the display box forms an aesthetically sound entity.

From the forgoing descriptions, it can be shown that the above-mentioned objects have been substantially accomplished. The present invention provides a display box which comprises an aesthetic locking arrangement for selectively locking up a foldable cover of the display box.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A display box, comprising:
a box body having a storage compartment and an access opening communicating with said storage compartment;
a foldable cover having a locker rim portion and a pivot rim portion pivotally connected to said box body to pivotally fold between an opened position that said foldable cover is pivotally unfolded to expose said storage compartment and a closed position that said foldable cover is pivotally folded at said access opening to enclose said storage compartment; and
an aesthetic locking arrangement, which comprises:
an aesthetic locker comprising a sliding tongue slidably mounted at said box body and a rim locker which is extended from said sliding tongue and is arranged in such a manner that when said sliding tongue is sidewardly slid towards said box body, said rim locker is substantially engaged with said locker rim portion of said foldable cover so as to lock up said foldable cover at said closed position, and when said sliding tongue is sidewardly slid away from said box body, said rim locker is driven to disengage with said locker rim portion of said foldable cover such that said foldable cover is free to pivotally fold between said opened position and said closed position.

2. The display box, as recited in claim 1, wherein said box body further has a sliding cavity formed above a bottom wall of said box and underneath said storage compartment thereof and a sliding opening formed on a sidewall of said box body to communicate with said sliding cavity, wherein said sliding tongue is slidably received in said sliding cavity through said sliding opening so as to slidably mount said rim locker with said box body.

3. The display box, as recited in claim 1, wherein said rim locker comprises a surrounding wall upwardly extended from said sliding tongue and a top engaging rim integrally extended on top of said surrounding wall to ride on said locker rim portion of said foldable cover when said sliding tongue is sidewardly slid towards said box body so as to lock up said foldable cover at said closed position.

4. The display box, as recited in claim 2, wherein said rim locker comprises a surrounding wall upwardly extended from said sliding tongue and a top engaging rim integrally extended on top of said surrounding wall to ride on said locker rim portion of said foldable cover when said sliding tongue is sidewardly slid towards said box body so as to lock up said foldable cover at said closed position.

5. The display box, as recited in claim 3, wherein said top engaging rim has a curved gripping portion formed on a top surface of said top engaging rim at a position above said foldable cover such that said gripping portion of said top engaging rim is adapted to be held to fold said foldable cover between said opened position and said closed position when said sliding tongue is slid away from said box body.

6. The display box, as recited in claim 4, wherein said top engaging rim has a curved gripping portion formed on a top surface of said top engaging rim at a position above said foldable cover such that said gripping portion of said top engaging rim is adapted to be held to fold said foldable cover between said opened position and said closed position when said sliding tongue is slid away from said box body.

7. The display box, as recited in claim 2, wherein said aesthetic locking arrangement further comprises a locker unit for locking said sliding tongue with said box body, wherein said locker unit has a locking slot formed on said sliding tongue and comprises a locking actuator, having a locking latch supported within said sliding cavity, movably mounted on said bottom wall of said box body and arrange in such a manner that when said sliding tongue is slid towards said box body, said locking latch is engaged with said locking slot to lock up said sliding tongue at said box body so as to retain said rim locker at said locker rim portion of said foldable cover to lock up said foldable cover at said closed position.

8. The display box, as recited in claim 4, wherein said aesthetic locking arrangement further comprises a locker unit for locking said sliding tongue with said box body, wherein said locker unit has a locking slot formed on said sliding tongue and comprises a locking actuator, having a locking latch supported within said sliding cavity, movably mounted on said bottom wall of said box body and arrange in such a manner that when said sliding tongue is slid towards said box body, said locking latch is engaged with said locking slot to lock up said sliding tongue at said box body so as to retain said rim locker at said locker rim portion of said foldable cover to lock up said foldable cover at said closed position.

9. The display box, as recited in claim 6, wherein said aesthetic locking arrangement further comprises a locker unit for locking said sliding tongue with said box body, wherein said locker unit has a locking slot formed on said sliding tongue and comprises a locking actuator, having a locking latch supported within said sliding cavity, movably mounted on said bottom wall of said box body and arrange in such a manner that when said sliding tongue is slid towards said box body, said locking latch is engaged with said locking slot to lock up said sliding tongue at said box body so as to retain said rim locker at said locker rim portion of said foldable cover to lock up said foldable cover at said closed position.

10. The display box, as recited in claim 7, wherein said locker unit further comprises a resilient element supported within said sliding cavity for applying an urging force against said sliding tongue so as to normally push said sliding tongue away from said box body.

11. The display box, as recited in claim 8, wherein said locker unit further comprises a resilient element supported within said sliding cavity for applying an urging force against said sliding tongue so as to normally push said sliding tongue away from said box body.

12. The display box, as recited in claim 9, wherein said locker unit further comprises a resilient element supported within said sliding cavity for applying an urging force against said sliding tongue so as to normally push said sliding tongue away from said box body.

13. The display box, as recited in claim 10, wherein said resilient element comprises a compression spring, wherein said locker unit further comprises two spring holders mounted at said sliding tongue and a ceiling of said sliding cavity to securely hold two ends of said compression spring of said resilient element in position respectively.

14. The display box, as recited in claim 11, wherein said resilient element comprises a compression spring, wherein said locker unit further comprises two spring holders mounted at said sliding tongue and a ceiling of said sliding cavity to securely hold two ends of said compression spring of said resilient element in position respectively.

15. The display box, as recited in claim 2, wherein said aesthetic locking arrangement further comprises a first stopper mounted within said sliding cavity and a second stopper which is mounted on said sliding tongue and is aligned with said first stopper such that when said sliding tongue is slid away from said body box, said second stopper is blocked by said first stopper so as to prevent said sliding tongue from sliding out of said sliding cavity.

16. The display box, as recited in claim 6, wherein said aesthetic locking arrangement further comprises a first stopper mounted within said sliding cavity and a second stopper which is mounted on said sliding tongue and is aligned with said first stopper such that when said sliding tongue is slid away from said body box, said second stopper is blocked by said first stopper so as to prevent said sliding tongue from sliding out of said sliding cavity.

17. The display box, as recited in claim 14, wherein said aesthetic locking arrangement further comprises a first stopper mounted within said sliding cavity and a second stopper which is mounted on said sliding tongue and is aligned with said first stopper such that when said sliding tongue is slid away from said body box, said second stopper is blocked by said first stopper so as to prevent said sliding tongue from sliding out of said sliding cavity.

18. The display box, as recited in claim 2, wherein said aesthetic locking arrangement further comprises a slider track formed in said sliding cavity and a sliding guider extended on said sliding tongue to slidably engage with said slider track so as to guide said sliding tongue to slide at said sliding cavity of said box body.

19. The display box, as recited in claim 16, wherein said aesthetic locking arrangement further comprises a slider track formed in said sliding cavity and a sliding guider extended on said sliding tongue to slidably engage with said slider track so as to guide said sliding tongue to slide at said sliding cavity of said box body.

20. The display box, as recited in claim 17, wherein said aesthetic locking arrangement further comprises a slider track formed in said sliding cavity and a sliding guider extended on said sliding tongue to slidably engage with said slider track so as to guide said sliding tongue to slide at said sliding cavity of said box body.
